(19) United States
(12) Patent Application Publication
(10) Pub. No.: US 2015/0212670 A1
(43) Pub. Date: Jul. 30, 2015

(54) Highly Customizable New Tab Page

(71) Applicants: Jeffrey Albert Chang, Palo Alto, CA (US); John Nicholas Jitkoff, Palo Alto, CA (US); Evan A. Stade, Los Angeles, CA (US)

(72) Inventors: Jeffrey Albert Chang, Palo Alto, CA (US); John Nicholas Jitkoff, Palo Alto, CA (US); Evan A. Stade, Los Angeles, CA (US)

(73) Assignee: Google Inc., Mountain View, CA (US)

(21) Appl. No.: 13/364,268

(22) Filed: Feb. 1, 2012

(51) Int. Cl. G06F 3/0483; G06F 3/0482; G06F 17/30; G06F 3/0486

(52) U.S. Cl. CPC G06F 3/0483; G06F 3/0486; G06F 3/0482; G06F 17/30876

(57) ABSTRACT

Configurations for providing a highly customizable new tab page are disclosed. The new tab page can include one or more panes for including different content. For instance, each pane can include a group of items such as applications, bookmarks, most visited sites, etc. In one example, the subject technology can provide one pane of automatically generated content, which is then followed by one or more panes with user-selectable content for a given new tab page. The user, for example, can choose to include all game applications in a first pane, all utility applications in a second pane, and all news applications in a third pane. Further, the user can include other types of content such as bookmarks in any pane with user-selectable content. Thus, each pane with user-selectable content can include one or more types of content. The user can also add or remove panes and rename the panes.

### BACKGROUND

A web client (e.g., a web browser) can include one or more tab windows for displaying different content.

### SUMMARY

The subject technology provides for providing a customizable tab page in a web client. The subject technology generates one or more panes in a tab page in which at least one pane from the generated one or more panes includes user-selectable content. The subject technology then provides for display a first pane from the generated one or more panes in which the first pane includes one or more items and each item is associated with a category of content.

Yet another aspect of the subject technology provides a system for providing a customizable tab page in a web client. The system includes memory, one or more processors and one or more modules stored in memory and configured for execution by the one or more processors. The system includes a tab management module configured to generate one or more panes in a tab page in which at least one pane from the generated one or more panes includes user-selectable content. The system further includes a GUI display module configured to provide for display a first pane from the generated one or more panes in which the first pane includes one or more items and each item is associated with a category of content.

The subject technology further provides for generating one or more panes in a tab page in which at least one pane from the generated one or more panes includes user-selectable content. A first pane from the generated one or more panes is provided for display in which the first pane includes one or more items and each item is associated with a category of content. A selection input is received for selecting an item in the first pane. The subject technology receives a user input for moving the selected item to a second pane from the generated one or more panes in the tab page. The selected item is then moved to the second pane from the generated one or more panes in response to the received user input.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The novel features of the subject technology are set forth in the appended claims. However, for purpose of explanation, several configurations of the subject technology are set forth in the following figures.

FIG. 1 conceptually illustrates an example process for providing a customizable tab page in a web client.

FIG. 2 conceptually illustrates an example process for moving an item from one pane to another pane in the tab page.

FIG. 3 conceptually illustrates an example process for removing an item from a pane of a tab page.

FIG. 4 conceptually illustrates an example process for navigating from a first pane to a second pane of a tab page.

FIG. 5 conceptually illustrates an example process for adding an item to a pane of a tab page.

FIG. 6 conceptually illustrates an example graphical user interface (GUI) of some configurations of the subject technology.

FIG. 7 conceptually illustrates an example computing environment.

FIG. 8 conceptually illustrates an example application programming interface (API) architecture.

FIG. 9 conceptually illustrates a system with which some implementations of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

When a new tab page is open in a given web client (e.g., a web browser), the web client can present different views to the user. In one example, the web client can present an empty window without any content. In another example, the web client can present a fixed display of automatically generated content (e.g., most visited sites). However, in a web-based operating system (e.g., in which the OS is designed to exclusively work with web applications), the web client can doubly serve as a user's desktop environment in which different applications and content can be displayed. Thus, extending the functionality of a new tab page to enable configuration of the content displayed in a new tab page would bring the functionality of the web client to more closely resemble a desktop of a traditional desktop OS.

To provide the aforementioned functionality, the subject technology provides a highly customizable new tab page. The new tab page can include one or more panes for including different content. For instance, each pane can include a group of items (e.g., graphically represented as icons in a grid layout) such as applications, bookmarks, most visited sites, etc. In one example, the subject technology can provide one pane of automatically generated content (e.g., most visited sites), which is then followed by one or more panes with user-selectable content for a given new tab page. The user, for example, can choose to include all game applications in a first pane, all utility applications in a second pane, and all news applications in a third pane. Further, the user can include other types of content such as bookmarks in any pane with user-selectable content. Thus, each pane with user-selectable content can include one or more types of content. The user can also add or remove panes and rename the panes.

Navigating between the panes can be accomplished through a keyboard shortcut, mouse-cursor selection, or a touch gesture (e.g., for touchscreen devices). In one example, a display area can be provided for navigating through each pane. For moving content within a pane, the user can drag and drop an item (e.g., icon) from a first position to a different position within the pane. Moreover, the user can move an item(s) from a first pane to a second pane. The user can also remove any content in a pane with user-selectable content.

In addition to the above, the subject technology can provide recommendations or suggestions for other applications based on existing applications, the usage pattern of the user, and/or the user's social graph or social networking profile. In another example, plugins or extensions to the web client can populate one or more panes with content. As used herein, the term “plugin” refers to one or more components that add specific features to a host application.

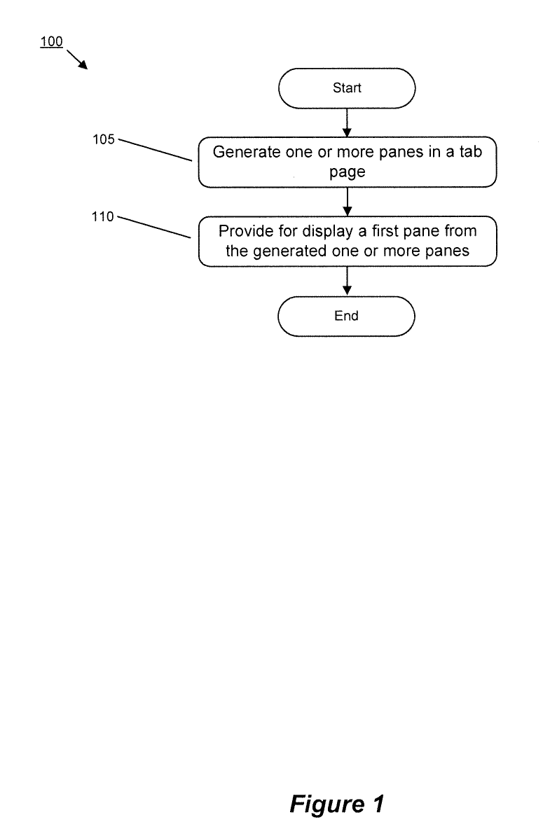

FIG. 1 conceptually illustrates an example process 100 for providing a customizable tab page in a web client. The process 100 is performed by one or more computing devices or systems in some configurations. For instance, a web client application (e.g., a web browser) can perform the operations in the process 100 described in further detail below in order to provide the customizable tab page.

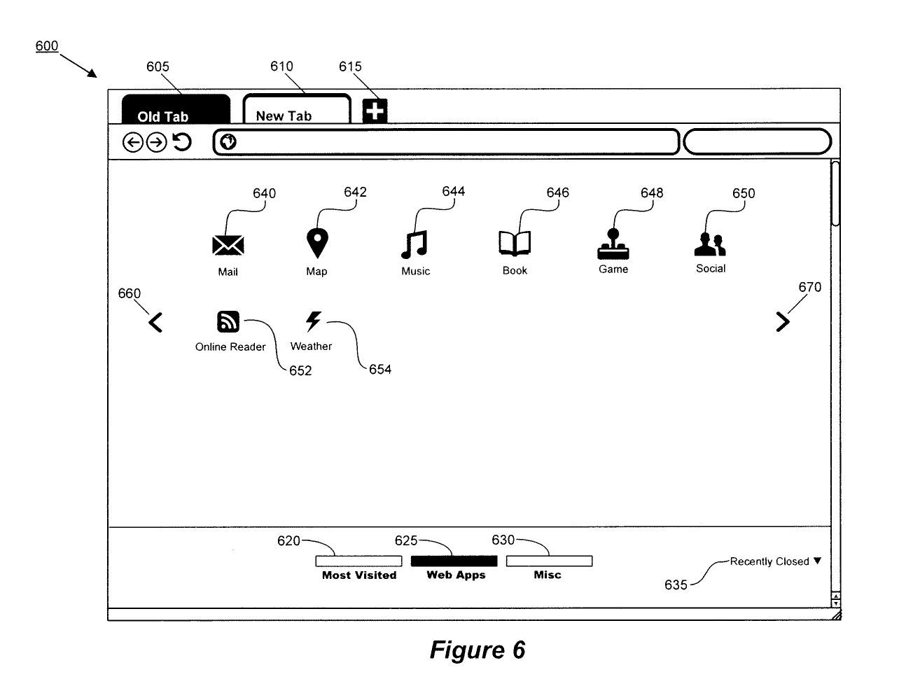

The process 100 begins at 105 by generating one or more panes in a tab page. In some configurations, at least one pane from the generated one or more panes includes user-selectable content. As utilized herein, the term “pane” refers to a grouping of one or more graphical representations of items visible in a display area in the tab page. An example graphical user interface (GUI) illustrating a pane within a tab page is described in further detail in connection with FIG. 6 below. In some configurations, generating one or more panes in the tab page is responsive to opening a new tab page. The one of more items are respective graphical representations that enable activation of a corresponding item upon a user selection input. A graphical representation among the respective graphical representations includes a scaled image rendering of a web page in some configurations.

The process 100 at 110 provides for display a first pane from the generated one or more panes. In one example, the first pane includes one or more items and each item is associated with a category of content. The one or more items can be arranged according to the example GUI described in FIG. 6 below. As used herein, in the context of a pane displayed a tab page, the category of content for each item includes one of a web application, plugin, bookmark, image, audio or video. Upon selection or activation of a respective item, the web client provides the content corresponding to the category of the item. Other types of content can be provided and still be within the scope of the subject technology. The process 100 then ends.

Different techniques can be utilized for providing one or more graphical representations in the tab page. In one example, a technique to crop webpage screenshots prior to scaling such that uninteresting areas (blank space) will be removed and the scaled-down thumbnail retains as much relevant visual info as possible. The technique accomplishes this by combining special knowledge of webpage layouts (for example, the top, “above the fold” region is always considered more interesting than the bottom) and entropy-based calculations (e.g., if there is more entropy in the center of the page it is considered more interesting than the left or right sides).

The process 100 is described above as generating one or more panes for a given tab page. In one example, the process 100 provides for display a third pane from the generated one or more panes in which the third pane includes one or more items that are automatically generated. For instance, the automatically generated one or more items includes a set of most visited web sites in an example. Other types of automatically generated items can be provided and still be within the scope of the subject technology.

Further, the process 100 can also determine one or more closed tab pages based on a navigation history of the web client. The process 100 can then provide for display a listing of the determined one or more closed tab pages. In some configurations, the process 100 provides for display a respective title for each of the generated one or more panes. In one example, the process 100 receives an input for renaming a respective title of the aforementioned first pane of the tab page. The process 100 then provides for display the renamed respective title of the first pane.

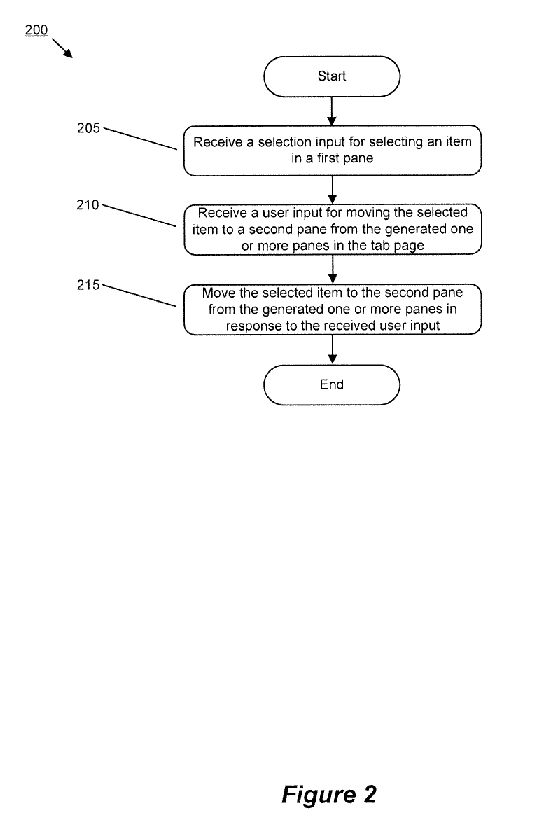

The customizable tab page provides various functionality that enables a user to modify and populate the content displayed in the tab page. Examples of different functionality is described in further detail in the description of FIGS. 2-5 below.

FIG. 2 conceptually illustrates an example process 200 for moving an item from one pane to another pane in the tab page. The process 200 can be performed by one or more computing devices or systems in some configurations. In some configurations, the process 200 can be performed in conjunction with the process 100 described above in FIG. 1 (e.g., after providing for display a pane including one or more items).

The process 200 begins at 205 by receiving a selection input for selecting an item in a first pane. In one example, the item is displayed as a graphical representation in illustrated in the example GUI of FIG. 6 described below. The selection input includes forms of user input including, but not limited to, a mouse cursor selection, a keyboard shortcut selection, a touch input selection (e.g., via a touchscreen device), etc. Other types of user input can be received for selecting the item in the first pane and still be within the scope of the subject technology.

The process 200 at 210 receives a user input for moving the selected item to a second pane from the generated one or more panes in the tab page. The process 200 at 215 then moves the selected item to the second pane from the generated one or more panes in response to the received user input. In some configurations, the second pane is dynamically generated after receiving the user input for moving the selected item. In other words, the second pane is a new pane that is now provided in the tab page. Alternatively, the second pane in one example is an existing pane of the tab page and includes one or more items. Irrespective if the second pane is new or existing, the selected item is now included in the second page when displayed in the tab page. Further, in some configurations, moving the selected item to the second pane removes the item from the first pane. Alternatively, in some configurations, the selected item is copied to the second pane without removing it from the first pane. The process 200 then ends.

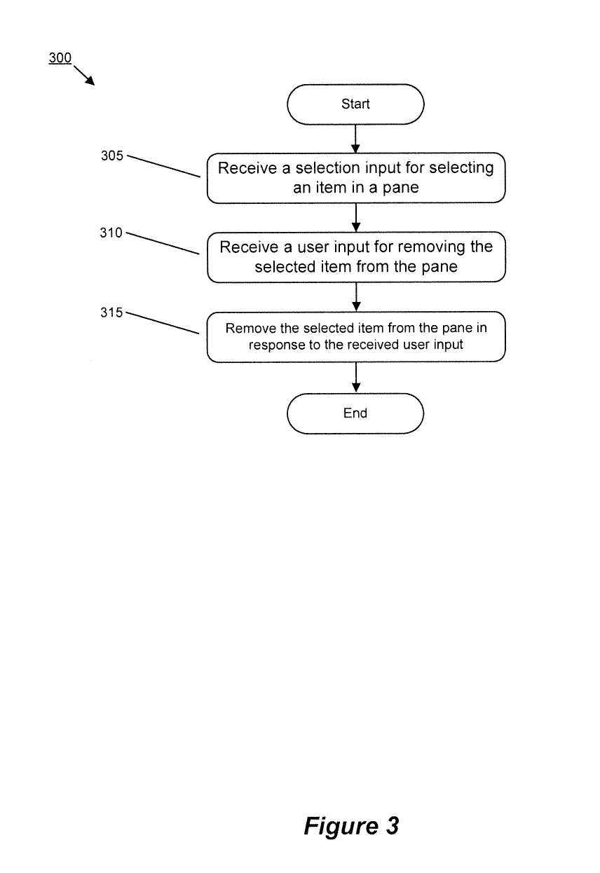

FIG. 3 conceptually illustrates an example process 300 for removing an item from a pane of a tab page. In some configurations, the process 300 is performed by one or more computing devices or systems to provide for removing an item from a pane in a tab page. In some configurations, the process 300 is performed conjunctively with the process 100 described above in FIG. 1.

The process 300 begins at 305 by receiving a selection input for selecting an item in a pane of a tab page. The process 300 at 310 then receives a user input for removing the selected item from the pane of the tab page. The user input can be a keyboard input, mouse input, touch input, or any combination of the preceding types of input. Other types of input can be received and still be within the scope of the subject technology. The process 300 then continues to 315 by removing the selected item from the pane in response to the received user input. Upon removal, the arrangement of items in the pane can be modified according to the removal of the selected item (e.g., to optimize the display of the items in the pane). The process 300 then ends.

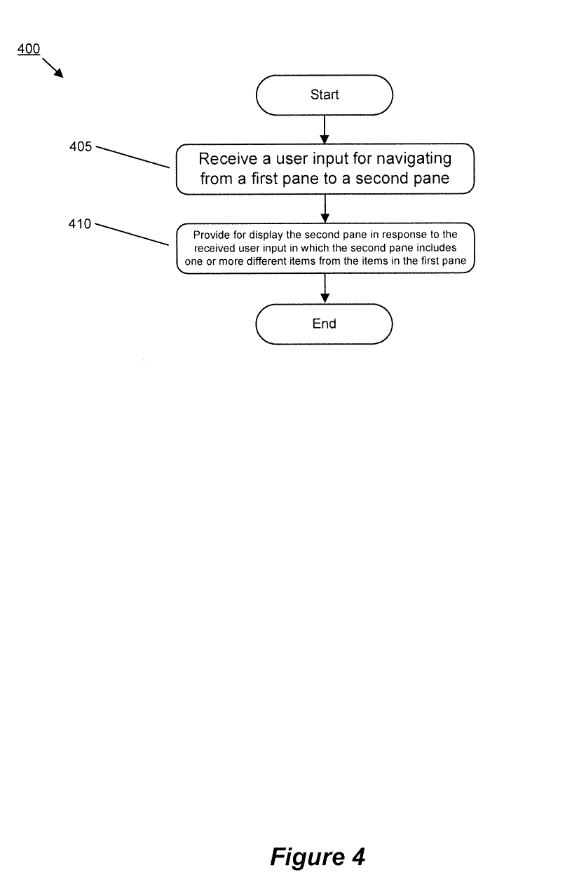

FIG. 4 conceptually illustrates an example process 400 for navigating from a first pane to a second pane of a tab page. In some configurations, the process 400 is performed on one or more computing devices or systems. The process 400 in some configurations is performed conjunctively with the process 100 described in FIG. 1 above.

The process 400 begins at 405 by receiving a user input for navigating from a first pane to a second pane. As mentioned before, the user input can be a keyboard input, mouse input, touch input, or any combination of the preceding types of input (or other types of input). The process continues to 410 by providing for display the second pane in response to the received user input. In some configurations, the second pane includes one or more different items from the items in the first pane. Navigating between panes enables the user to display different items included in a different pane of the tab page. In particular, each pane can organize items differently and include different categories of content as described above. The process 400 then ends.

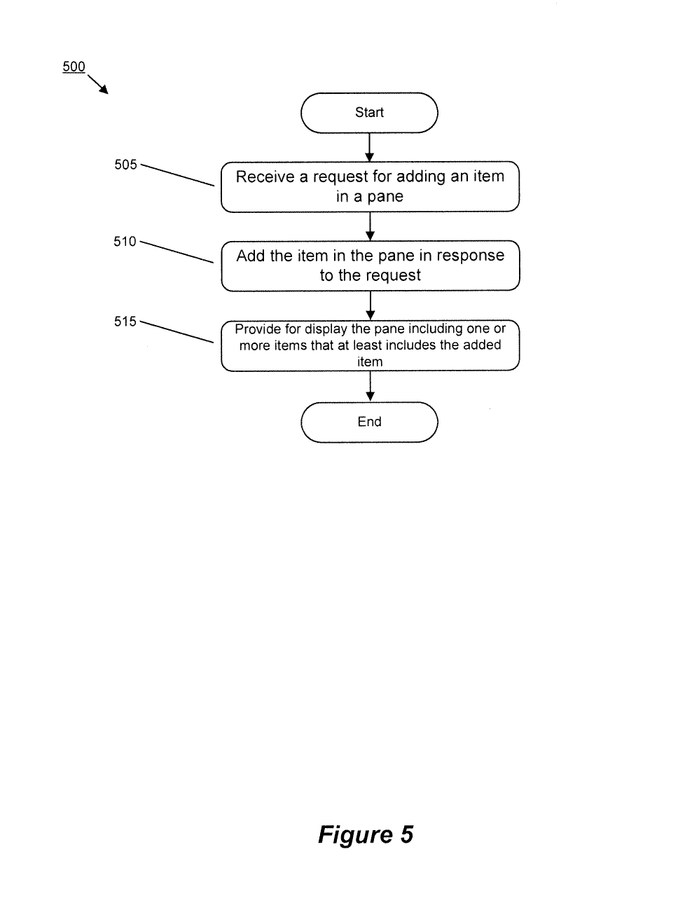

FIG. 5 conceptually illustrates an example process for adding an item to a pane of a tab page. In some configurations, the process 500 is performed on one or more computing devices or systems. The process 500 in some configurations is performed conjunctively with the process 100 described in FIG. 1 above.

The process 500 begins at 505 by receiving a request for adding an item in a pane. The process continues to 510 by adding the item in the pane in response to the request. At 515, the process 500 provides for display the pane including one or more items that at least includes the added item. In this manner, the process 500 enables the user to include an additional item(s) in the pane of the tab page. The process 500 then ends.

FIG. 6 conceptually illustrates a graphical user interface (GUI) 600 in which some configurations of the subject technology can be implemented. More specifically, the GUI 600 can include different sets of graphical elements for displaying one or more panes in a tab page as described by reference to the respective processes described in FIGS. 1-5. A graphical element can include, but is not limited to, a button, check box, radio button, slider, list box, drop-down list, menu, combo box, icon, text box, scroll bar, etc. In one example, the GUI 600 is displayed in a web client (e.g., web browser or web-based operating system).

The GUI 600 can also include tab pages 605 and 610. In the example shown in FIG. 6, the tab page 605 is considered an old tab page which includes web content in one example. The tab page 610 is illustrated as a new tab page that is provided when activating the web client's functionality for creating or generating a new tab page. For instance, a graphical element 615 shown in FIG. 6, upon a selection input, generates one or more panes in a new tab page.

As further shown in FIG. 6, the new tab page 610 includes three different panes 620, 625 and 630. In the example GUI 600 of FIG. 6, the pane 625 corresponding to the “Web Apps” pane is currently shown (as indicated in bold) in the tab page 610. The tab page 610 includes items 640, 642, 644, 646, 648, 650, 652 and 654. Each respective item corresponds to a category of content, such as a web application, plugin, bookmark, image, audio or video. Other categories of content can be provided and still be within the scope of the subject technology.

As shown in the GUI 600, the items in the pane 625 are arranged in a grid organized in two different rows with a predetermined number of displayed items per row. The items can be arranged in alternative ways and still be within the scope of the subject technology. For instance, the GUI 600 can arrange the items in the pane 625 according to one or more different criteria that organizes the items in different rows, different columns and/or other asymmetric or symmetric graphical arrangements and geometries. Further each item can be displayed utilizing a different technique. In one example, one item is provided as a graphical icon, while a second item is provided as a scaled or zoomed screen shot (e.g., a screen shot of a web page).

For navigating between other panes such as the pane 620 and the pane 630, respective graphical elements 660 and 670 are provided in the GUI 600. In one example, a selection input of the graphical element 660 navigates from the pane 625 to the pane 620. Similarly, a selection input of the pane 670 navigates from the pane 625 to the pane 630. Additionally, a selection input of the pane 620 or the pane 630 displays the selected pane in the GUI 600. In the example GUI 600, the user provides an input for selecting the pane 620 (e.g., mouse-click input, touch input, etc.) to display the pane 620 in the GUI 600, or likewise provides an input for selecting the pane 630 to display the pane 630 in the GUI 600. Subsequently, the user can then provide a selection input for the pane 625 to display the pane 625 in the GUI 600.

Although the example GUI 600 in FIG. 6 includes three different panes 620, 625 and 630, any number of panes can be included in the GUI 600 and still be within the scope of the subject technology. Moreover, the respective graphical representations of items in each pane can be arranged in the GUI 600 in different ways not described herein and still be within the scope of the subject technology.

Additionally, although the above description of FIG. 6 includes different example graphical elements in the GUI 600, some implementations can include other graphical elements in the GUI 600 and still be within the scope of the subject technology. Further, the GUI 600 is not required to include all of the aforementioned graphical elements.

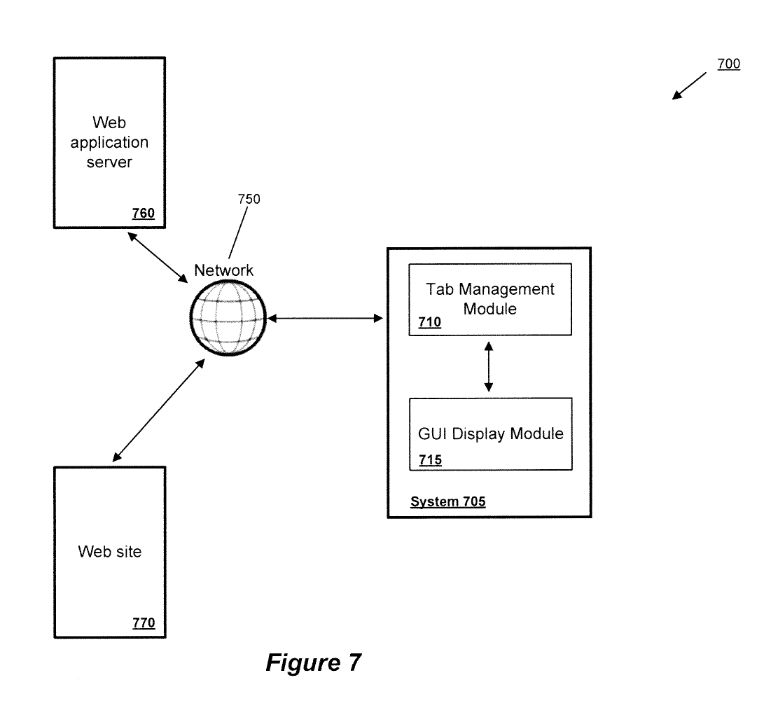

FIG. 7 conceptually illustrates an example computing environment 700 including a system. In particular, FIG. 7 shows a system 705 for implementing the above described processes in FIGS. 1-5 and for providing the GUI illustrated in FIG. 6. In some configurations, the system 705 is part of an implementation running a particular machine (e.g., a client computing device, client machine, etc.).

The system 705 can include memory, one or more processors, and one or more modules stored in memory and configured for execution by the one or more processors. As shown in FIG. 7, the system 705 includes several modules for providing different functionality. The system 705 is configured to include a tab management module 710 and a GUI display module 715. The tab management module 710 is configured to generate one or more panes in a tab page in which at least one pane from the generated one or more panes includes user-selectable content. The GUI display module 715 is configured to provide for display a first pane from the generated one or more panes in which the first pane includes one or more items and each item is associated with a category of content. In some configurations, the one of more items are respective graphical representations that enable activation of a corresponding item upon a user selection input. A graphical representation among the respective graphical representations includes a scaled image rendering of a web page in one example. The GUI display module 715 is further configured to provide for display the second pane in response to the received user input in which the second pane includes one or more different items from the items in the first pane.

The tab management module 710 is further configured to receive a selection input for selecting an item in the first pane, receive a user input for moving the selected item to a second pane from the generated one or more panes in the tab page, and move the selected item to the second pane from the generated one or more panes in response to the received user input. The tab management module 710 is configured to receive a user input for navigating from the first pane to a second pane in one example.

As further shown in FIG. 7, each of the aforementioned modules can be configured to communicate between each other. For instance, different data, messages, API calls and returns can be passed between the different modules in the system 705.

The system 705 can communicate over a network 750 with a web application server 760 and a web site 770. The web application server 760 and the web site 770 can each be configured to communicate with the aforementioned modules of the system 705. For instance, the system 705 can transmit a request over the network 750 to the web application server 760 and/or the web site 770.

Many of the above-described features and applications are implemented as software processes that are specified as a set of instructions recorded on a machine readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of machine readable media include, but are not limited to, CD-ROMs, flash drives, RAM chips, hard drives, EPROMs, etc. The machine readable media does not include carrier waves and electronic signals passing wirelessly or over wired connections.

In this specification, the term “software” is meant to include firmware residing in read-only memory and/or applications stored in magnetic storage, which can be read into memory for processing by a processor. Also, in some implementations, multiple software components can be implemented as sub-parts of a larger program while remaining distinct software components. In some implementations, multiple software subject components can also be implemented as separate programs. Finally, any combination of separate programs that together implement a software component(s) described here is within the scope of the subject technology. In some implementations, the software programs, when installed to operate on one or more systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some configurations are implemented as software processes that include one or more application programming interfaces (APIs) in an environment with calling program code interacting with other program code being called through the one or more interfaces. Various function calls, messages or other types of invocations, which can include various kinds of parameters, can be transferred via the APIs between the calling program and the code being called. In addition, an API can provide the calling program code the ability to use data types or classes defined in the API and implemented in the called program code.

One or more APIs may be used in some configurations. An API is an interface implemented by a program code component or hardware component (“API implementing component”) that allows a different program code component or hardware component (“API calling component”) to access and use one or more functions, methods, procedures, data structures, classes, and/or other services provided by the API implementing component. An API can define one or more parameters that are passed between the API calling component and the API implementing component.

An API allows a developer of an API calling component (that could be a third party developer) to utilize specified features provided by an API implementing component. There may be one API calling component or there may be more than one such component. An API can be a source code interface that a computing system or program library provides to support requests for services from an application. An operating system (OS) can have multiple APIs to allow applications running on the OS to call one or more of those APIs, and a service (such as a program library) can have multiple APIs to allow an application that uses the service to call one or more of those APIs. An API can be specified in terms of a programming language that can be interpreted or compiled when an application is built.

In some configurations the API implementing component may provide more than one API, each providing a different view of or with different aspects that access different aspects of the functionality implemented by the API implementing component. For example, one API of an API implementing component can provide a first set of functions and can be exposed to third party developers, and another API of the API implementing component can be hidden (not exposed) and provide a subset of the first set of functions and also provide another set of functions, such as testing or debugging functions which are not in the first set of functions. In other configurations the API implementing component may itself call one or more other components via an underlying API and thus be both an API calling component and an API implementing component.

An API defines the language and parameters that API calling components use when accessing and using specified features of the API implementing component. For example, an API calling component accesses the specified features of the API implementing component through one or more API calls or invocations (embodied for example by function or method calls) exposed by the API and passes data and control information using parameters via the API calls or invocations. The API implementing component may return a value through the API in response to an API call from an API calling component. While the API defines the syntax and result of an API call (e.g., how to invoke the API call and what the API call does), the API may not reveal how the API call accomplishes the function specified by the API call. Various API calls are transferred via the one or more application programming interfaces between the calling (API calling component) and an API implementing component. Transferring the API calls may include issuing, initiating, invoking, calling, receiving, returning, or responding to the function calls or messages. In other words, transferring can describe actions by either of the API calling component or the API implementing component. The function calls or other invocations of the API may send or receive one or more parameters through a parameter list or other structure. A parameter can be a constant, key, data structure, object, object class, variable, data type, pointer, array, list or a pointer to a function or method or another way to reference a data or other item to be passed via the API.

Furthermore, data types or classes may be provided by the API and implemented by the API implementing component. The API calling component therefore can declare variables, use pointers to, use or instantiate constant values of such types or classes by using definitions provided in the API.

Generally, an API can be used to access a service or data provided by the API implementing component or to initiate performance of an operation or computation provided by the API implementing component. By way of example, the API implementing component and the API calling component may each be any one of an operating system, a library, a device driver, an API, an application program, or other module (it should be understood that the API implementing component and the API calling component may be the same or different type of module from each other). API implementing components may in some cases be embodied at least in part in firmware, microcode, or other hardware logic. In some configurations, an API may allow a client program to use the services provided by a Software Development Kit (SDK) library. In other configurations an application or other client program may use an API provided by an Application Framework. In these configurations the application or client program may incorporate calls to functions or methods provided by the SDK and provided by the API or use data types or objects defined in the SDK and provided by the API. An Application Framework may in these configurations provide a main event loop for a program that responds to various events defined by the Framework. The API allows the application to specify the events and the responses to the events using the Application Framework. In some implementations, an API call can report to an application the capabilities or state of a hardware device, including those related to aspects such as input capabilities and state, output capabilities and state, processing capability. power state, storage capacity and state, communications capability, etc., and the API may be implemented in part by firmware, microcode, or other low level logic that executes in part on the hardware component.

The API calling component may be a local component (i.e., on the same data processing system as the API implementing component) or a remote component (i.e., on a different data processing system from the API-implementing component) that communicates with the API-implementing component through the API over a network. It should be understood that an API implementing component may also act as an API calling component (i.e., it may make API calls to an API exposed by a different API implementing component) and an API calling component may also act as an API implementing component by implementing an API that is exposed to a different API calling component.

The API can allow multiple API calling components written in different programming languages to communicate with the API implementing component (thus the API may include features for translating calls and returns between the API implementing component and the API calling component). The API however can be implemented in terms of a specific programming language. An API calling component can, in one configuration, call APIs from different providers such as a set of APIs from an OS provider and another set of APIs from a plug-in provider and another set of APIs from another provider (e.g. the provider of a software library) or creator of the another set of APIs.

The following description describes an example API architecture in which some configurations of the subject technology can be implemented.

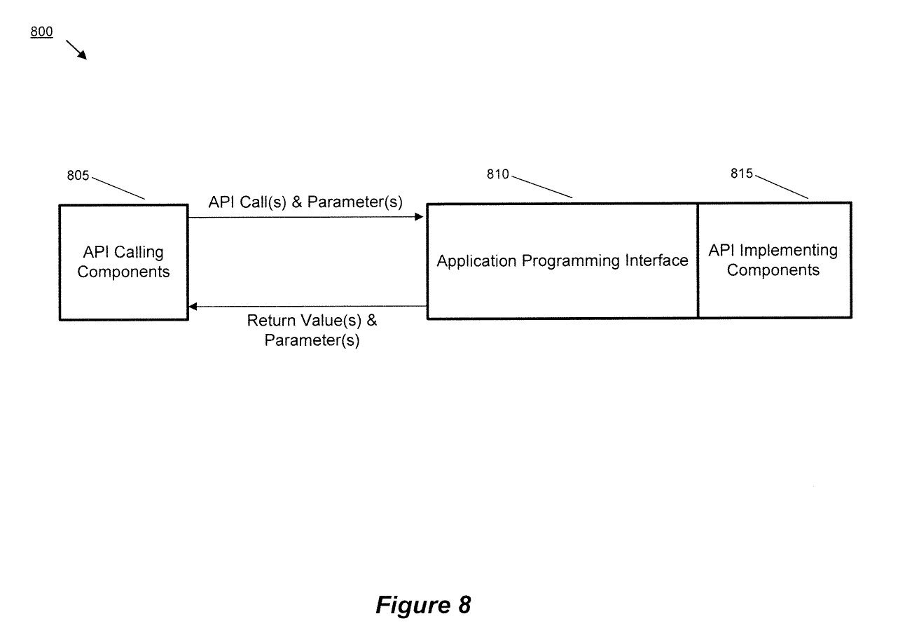

FIG. 8 is a block diagram illustrating an example API architecture, which can be used in some configurations of the subject technology. As shown in FIG. 8, the API architecture 800 includes the API implementing component 815 (e.g., an operating system, a library, a device driver, an API, an application program, software or other module) that implements the API 810. The API 810 specifies one or more functions, methods, classes, objects, protocols, data structures, formats and/or other features of the API-implementing component that can be used by the API-calling component 805. The API 810 can specify at least one calling convention that specifies how a function in the API implementing component receives parameters from the API calling component and how the function returns a result to the API calling component. The API calling component 805 (e.g., an operating system, a library, a device driver, an API, an application program. software or other module), makes API calls through the API 810 to access and use the features of the API implementing component 815 that are specified by the API 810. The API implementing component 815 can return a value through the API 810 to the API calling component 805 in response to an API call.

It will be appreciated that the API implementing component 815 can include additional functions, methods, classes, data structures, and/or other features that are not specified through the API 810 and are not available to the API calling component 805. It should be understood that the API calling component 805 can be on the same system as the API implementing component 815 or can be located remotely and accesses the API implementing component 815 using the API 810 over a network. While FIG. 8 illustrates a single API calling component 805 interacting with the API 810, it should be understood that other API calling components, which can be written in different languages (or the same language) than the API calling component 805, can use the API 810.

The API implementing component 815, the API 810, and the API calling component 805 can be stored in a machine-readable medium, which includes any mechanism for storing information in a form readable by a machine (e.g., a computer or other data processing system). For example, a machine-readable medium includes magnetic disks, optical disks, random access memory, read only memory, flash memory devices, etc.

The following description describes an example system in which aspects of the subject technology can be implemented.

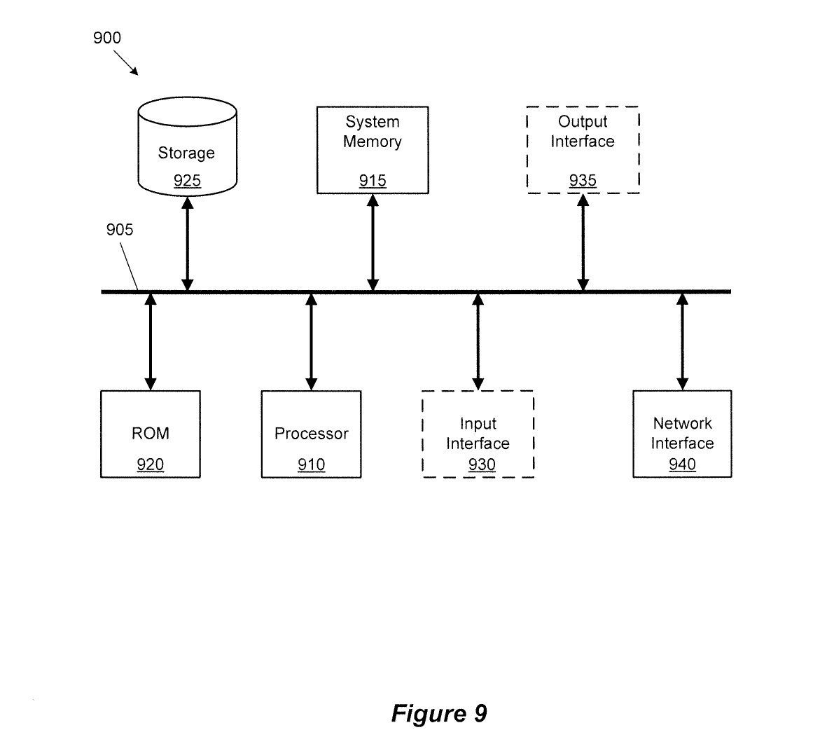

FIG. 9 conceptually illustrates a system 900 with which some implementations of the subject technology can be implemented. The system 900 can be a computer, phone, PDA, or any other sort of electronic device. In some configurations, the system 900 includes a television with one or more processors embedded therein. Such a system includes various types of computer readable media and interfaces for various other types of computer readable media. The system 900 includes a bus 905, processing unit(s) 910, a system memory 915, a read-only memory 920, a storage device 925, an optional input interface 930, an optional output interface 935, and a network interface 940.

The bus 905 collectively represents all system, peripheral, and chipset buses that communicatively connect the numerous internal devices of the system 900. For instance, the bus 905 communicatively connects the processing unit(s) 910 with the read-only memory 920, the system memory 915, and the storage device 925.

From these various memory units, the processing unit(s) 910 retrieves instructions to execute and data to process in order to execute the processes of the subject technology. The processing unit(s) can be a single processor or a multi-core processor in different implementations.

The read-only-memory (ROM) 920 stores static data and instructions that are needed by the processing unit(s) 910 and other modules of the system 900. The storage device 925, on the other hand, is a read-and-write memory device. This device is a non-volatile memory unit that stores instructions and data even when the system 900 is off. Some implementations of the subject technology use a mass-storage device (such as a magnetic or optical disk and its corresponding disk drive) as the storage device 925.

Other implementations use a removable storage device (such as a flash drive, a floppy disk, and its corresponding disk drive) as the storage device 925. Like the storage device 925, the system memory 915 is a read-and-write memory device. However, unlike storage device 925, the system memory 915 is a volatile read-and-write memory, such a random access memory. The system memory 915 stores some of the instructions and data that the processor needs at runtime. In some implementations, the subject technology's processes are stored in the system memory 915, the storage device 925, and/or the read-only memory 920. For example, the various memory units include instructions for processing multimedia items in accordance with some implementations. From these various memory units, the processing unit(s) 910 retrieves instructions to execute and data to process in order to execute the processes of some implementations.

The bus 905 also connects to the optional input and output interfaces 930 and 935. The optional input interface 930 enables the user to communicate information and select commands to the system. The optional input interface 930 can interface with alphanumeric keyboards and pointing devices (also called “cursor control devices”). The optional output interface 935 can provide display images generated by the system 900. The optional output interface 935 can interface with printers and display devices, such as cathode ray tubes (CRT) or liquid crystal displays (LCD). Some implementations can interface with devices such as a touchscreen that functions as both input and output devices.

Finally, as shown in FIG. 9, bus 905 also couples system 900 to a network interface 940 through a network adapter (not shown). In this manner, the computer can be a part of a network of computers (such as a local area network (“LAN”), a wide area network (“WAN”), or an Intranet, or an interconnected network of networks, such as the Internet. Any or all components of system 900 can be used in conjunction with the subject technology.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Configurations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some configurations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of example approaches. Based upon design preferences, it is understood that the specific order or hierarchy of steps in the processes can be rearranged, or that all illustrated steps be performed. Some of the steps can be performed simultaneously. For example, in certain circumstances, multitasking and parallel processing can be advantageous. Moreover, the separation of various system components in the configurations described above should not be understood as requiring such separation in all configurations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein can be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject technology.

A phrase such as an “aspect” does not imply that such aspect is essential to the subject technology or that such aspect applies to all configurations of the subject technology. A disclosure relating to an aspect can apply to all configurations, or one or more configurations. A phrase such as an aspect can refer to one or more aspects and vice versa. A phrase such as a “configuration” does not imply that such configuration is essential to the subject technology or that such configuration applies to all configurations of the subject technology. A disclosure relating to a configuration can apply to all configurations, or one or more configurations. A phrase such as a configuration can refer to one or more configurations and vice versa.

The word “example” is used herein to mean “serving as an example or illustration.” Any aspect or design described herein as “example” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

1. A machine-implemented method for providing a customizable tab page in a web client, the method comprising:
generating multiple panes for display in a tab page of a web browser, each pane configured to be individually selected by a navigation action performed within the tab page, wherein at least one pane from the generated multiple panes includes one or more user-selectable content items, the multiple panes configured such that a respective user-selectable content item may be repositioned within a currently selected pane displayed in the tab page of the web browser by a selection and dragging of the content item within the currently selected pane, and moved from a starting pane to a destination pane within the tab page of the web browser by a selection and dragging of the content item from the starting pane to the destination pane; and
providing for display the tab page of the web browser and a first pane selected by a respective navigation action from the generated multiple panes within the tab page of the web browser, wherein the first pane includes the one or more user-selectable content items, each content item being associated with a category of content.

2. The method of claim 1, wherein generating multiple panes in the tab page is responsive to opening a new tab page.

3. The method of claim 1, wherein the category of content includes one of a web application, plugin, bookmark, image, audio or video.

4. The method of claim 1, further comprising;
receiving a selection input for selecting an item in the first pane;
receiving a user input for moving the selected item to a second pane from the generated multiple panes in the tab page; and
moving the selected item to the second pane from the generated one or more panes in response to the received user input.

5. The method of claim 4, wherein the second pane is dynamically generated after receiving the user input for moving the selected item.

6. The method of claim 1, further comprising:
providing for display a third pane from the generated multiple panes, wherein the third pane includes one or more items that are automatically generated.

7. The method of claim 6, wherein the automatically generated one or more items includes a set of most visited web sites.

8. The method of claim 1, further comprising:
receiving a selection input for selecting an item in the first pane;
receiving a user input for removing the selected item from the first pane; and
removing the selected item from the first pane in response to the received user input.

9. The method of claim 1, further comprising:
providing for display a respective title for each of the generated multiple panes.

10. The method of claim 9, further comprising:
receiving an input for renaming the respective title of the first pane; and
providing for display the renamed respective title of the first pane.

11. The method of claim 1, wherein the one or more user-selectable content items are respective graphical representations that enable activation of a corresponding item upon a user selection input.

12. The method of claim 10, wherein a graphical representation among the respective graphical representations includes a scaled image rendering of a web page.

13. The method of claim 1, further comprising:
receiving a user input for navigating from the first pane to a second pane;
providing for display the second pane within the tab page in response to the received user input, wherein the second pane includes one or more different items from the one or more user-selectable content items in the first pane.

14. The method of claim 1, further comprising:
determining one or more closed tab pages based on a navigation history of the web client; and
providing for display a listing of the determined one or more closed tab pages.

15. A system for providing a customizable tab page in a web client:
memory;
one or more processors;
one or more modules stored in memory and configured for execution by the one or more processors, the modules comprising:
a tab management module configured to generate multiple panes for display in a tab page of a web browser, each pane configured to be individually selected by a navigation action performed within the tab page, wherein at least one pane from the generated multiple panes includes one or more user-selectable content items, the multiple panes configured such that a respective user-selectable content item may be repositioned within a currently selected pane displayed in the tab page of the web browser by a selection and dragging of the content item within the currently selected pane, and moved from a starting pane to a destination pane within the tab page of the web browser by a selection and dragging of the content item from the starting pane to the destination pane; and
a GUI display module configured to provide for display the tab page of the web browser and a first pane selected by a respective navigation action from the generated multiple panes within the tab page of the web browser, wherein the first pane includes the one or more user-selectable content items, each content item being associated with a category of content.

16. The system of claim 15, wherein the tab management module is further configured to:
receive a selection input for selecting an item in the first pane;
receive a user input for moving the selected item to a second pane from the generated multiple panes in the tab page; and
move the selected item to the second pane from the first pane in response to the received user input.

17. The system of claim 15, wherein the one of more user-selectable content items are respective graphical representations that enable activation of a corresponding item upon a user selection input.

18. The system of claim 17, wherein a graphical representation among the respective graphical representations includes a scaled image rendering of a web page.

19. The system of claim 18, wherein the tab management module is further configured to:
receive a user input for navigating from the first pane to a second pane.

20. The system of claim 19, wherein the GUI display module is further configured to:
provide for display within the web browser the second pane in response to the received user input, wherein the second pane includes one or more different items from the one or more user-selectable content items in the first pane.

21. A machine-readable medium comprising instructions stored therein, which when executed by a machine, cause the machine to perform operations comprising:
generating multiple panes for display in a tab page of a web browser, each pane configured to be individually selected by a navigation action performed within the tab page, wherein at least one pane from the generated multiple panes includes one or more user-selectable content items;
providing for display a first pane selected by a respective navigation action from the generated multiple panes, wherein the first pane includes the one or more user-selectable content items, each content item being associated with a category of content, the first pane configured such that a respective user-selectable content item may be repositioned within the selected displayed first pane by a selection and dragging of the respective user-selectable content item within the selected displayed first pane;
receiving a selection input for selecting a user-selectable content item in the selected first pane displayed in the tab page of the web browser;
receiving a user input within the tab page of the web browser for moving the selected user-selectable content item to a second pane from the generated multiple panes in the tab page; and
moving the selected item to the second pane from the first pane in response to the received user input.
